(19) United States
(12) Patent Application Publication
(10) Pub. No.: US 2025/0138406 A1
(43) Pub. Date: May 1, 2025

(54) PROJECTOR

(71) Applicant: CASIO COMPUTER CO., LTD., Tokyo (JP)

(72) Inventor: Masahiro OGAWA, Tokyo (JP)

(21) Appl. No.: 18/932,083

(22) Filed: Oct. 30, 2024

(30) Foreign Application Priority Data
Oct. 31, 2023 (JP) 2023-186505

(51) Int. Cl. G03B 21/20; G03B 21/00; G03B 21/28

(52) U.S. Cl. CPC G03B 21/208; G03B 21/006; G03B 21/2033; G03B 21/28

(57) ABSTRACT

A projector includes a light source, a diffractive optical element on which light from the light source is incident, and a display on which the light diffracted by the diffractive optical element is incident, and the diffractive optical element projects the light emitted therefrom onto the display in a dot pattern, and the display generates image light using at least a portion of the light projected in a dot pattern.

### CROSS-REFERENCE TO RELATED APPLICATION

This patent application is based upon and claims the benefit of priority under 35 USC 119 of Japanese Patent Application No. 2023-186505 filed on Oct. 31, 2023, the entire disclosure of which, including the specification, claims, drawings, and abstract, is incorporated herein by reference.

### BACKGROUND

### Technical Field

The present disclosure relates to a projector.

### Description of the Related Art

Today, projectors that project image data stored in personal computer screens, video screens, memory cards, and the like onto a screen are widely used. In this type of projector, it is known that light emitted from a light source is diffracted by a diffractive optical element to display an image on a screen. For example, Japanese Patent Application Laid-Open No. 2023-43061 discloses a projector that includes a light source, a diffractive optical element configured to diffract a laser beam emitted from the light source in a two-dimensional direction, and a lens configured to receive parallel laser beams emitted from the diffractive optical element and emit converged light.

### SUMMARY

According to an aspect of the present disclosure, there is provided a projector including a light source, a diffractive optical element on which light from the light source is incident, and a display on which the light diffracted by the diffractive optical element is incident, wherein the diffractive optical element projects the light emitted therefrom onto the display in a dot pattern, and wherein the display generates image light using at least a portion of the light projected in a dot pattern.

### BRIEF DESCRIPTION OF THE DRAWINGS

FIG. 1A is a schematic plan view showing schematically a projector according to a first embodiment of the present disclosure, and FIG. 1B is a schematic plan view showing an emission mode of light emitted from the projector according to the first embodiment;

FIG. 2A is a schematic front view showing a distribution mode of diffracted light projected onto a liquid crystal display element, FIG. 2B is a schematic front view showing a light transmitting area and a light blocking area on the liquid crystal display element, and FIG. 2C is a schematic front view showing image light projected onto a screen;

FIG. 3 is a schematic plan view showing an emission mode of light emitted from a projector according to a second embodiment;

FIG. 4 is a schematic view schematically showing a diffractive optical element driver;

FIG. 5 is a schematic plan view showing an emission mode of light emitted from a projector according to a third embodiment;

FIG. 6 is a schematic plan view showing an emission mode of light emitted from a projector according to a fourth embodiment; and

FIG. 7 is a schematic plan view showing a blue light incident area of a diffractive optical element of the projector according to the fourth embodiment.

### DESCRIPTION OF THE EMBODIMENT

### First Embodiment

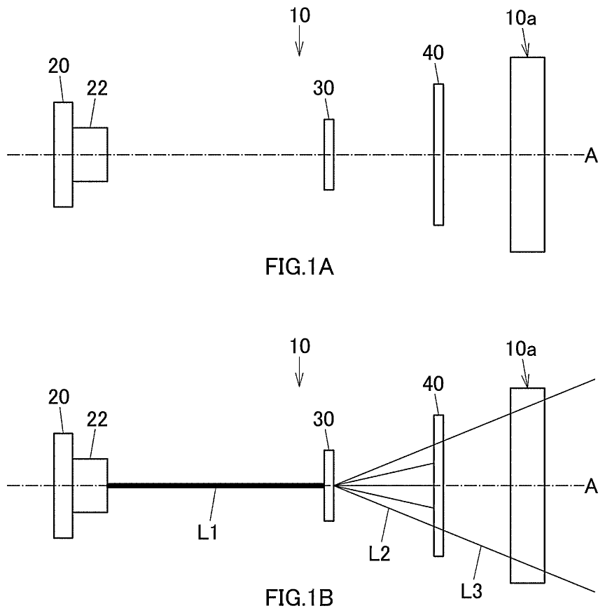

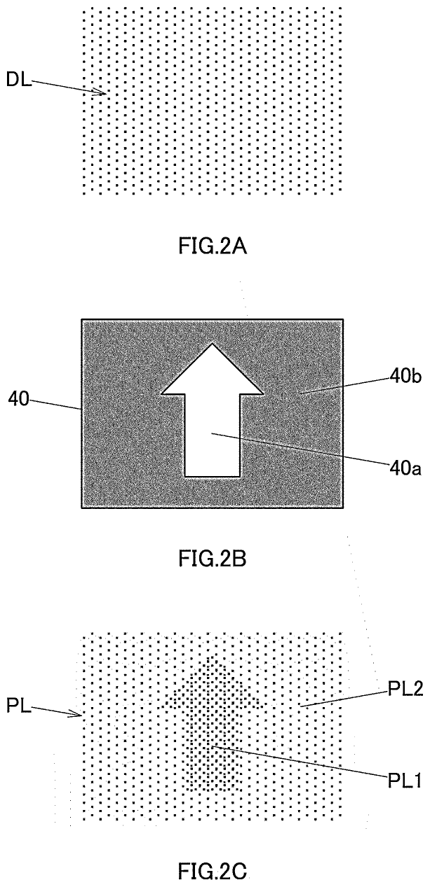

Hereinafter, referring to FIGS. 1A, 1B, 2A, 2B, and 2C, a first embodiment of the present disclosure will be described. The projector 10 shown in FIG. 1A includes a housing (not shown) and is equipped with a light-emitting element (a light source) 22, a diffractive optical element 30, and a liquid crystal display element (a display) 40 inside the housing. A projection opening 10a is provided in an external wall of the housing of the projector 10 so as to constitute an opening through which light from the light-emitting element 22 is emitted to an exterior of the housing. The light-emitting element 22, the diffractive optical element 30, the liquid crystal display element 40, and the projection opening 10a are provided in this order on the same straight line along an axis A shown in FIG. 1A.

The projector 10 forms an optical image in the liquid crystal display element 40 by irradiating a pencil of light emitted from the light-emitting element 22 to the liquid crystal display element 40 by way of the diffractive optical element 30 and then projects an image on a projection target, not shown, such as a screen for display thereon. Here, although not shown, various components that a known projector includes such as a heatsink and a cooling fan, and a controller for controlling and supervising an electrical configuration of the projector 10 are provided in the interior of the housing. In the following description, a side where the projection opening 10a is provided will be referred to as a front side, a direction along the axis A will be referred to as a front-rear direction of the projector 10, and a left-right direction with respect to a projecting direction from the projector 10 towards the projection target will be referred to as a left-right direction of the projector 10.

The light-emitting element 22 is a laser light source and is made up of a semiconductor light-emitting element such as a laser diode. The light-emitting element 22 is provided on a light source substrate 20 and emits rectilinear laser light L1 (refer to FIG. 1B) towards the diffractive optical element 30. As shown in FIG. 1B, the laser light L1 emitted from the light-emitting element 22 is emitted in such a way that an optical axis thereof extends on and along the axis A.

The diffractive optical element 30 is an optical element composed of multiple substantially plate-shaped diffraction gratings with varying lattice spacings, which are formed by a fine concave-convex structure and layered together. The light incident surface and the light emission surface of the diffractive optical element 30 are arranged perpendicular to the axis A. The diffractive optical element 30 diffracts the laser light L1, which is emitted parallelly from the light-emitting element 22, into multiple beams and emits them toward the liquid crystal display element 40. Furthermore, the diffraction optical element 30 diffracts the incident laser light L1 in such a way that it is projected onto the liquid crystal display element 40 in a dot pattern (hereinafter, the light emitted from the diffractive optical element 30 and projected onto the liquid crystal display element 40 is referred to as “diffracted light L2”).

Namely, as shown in FIG. 2A, the laser light L1 incident on the diffractive optical element 30 is diffracted in such a way as to branch into multiple sub-beams and is then emitted from the diffractive optical element 30 as diffracted light L2 so as to be projected in a dot pattern onto the liquid crystal display element 40 (hereinafter, bright points projected in a dot pattern onto the liquid crystal display element 40 will be referred to a “dot light DL”.). The number of dot lights DL projected onto the liquid crystal display element 40 is increased or decreased in accordance with the number of diffraction gratings making up the diffractive optical element 30. In practice, a single element that consolidates the function of multiple layered diffraction gratings is used.

The liquid crystal display element 40 is a substantially plate-shaped component and is disposed in such a way that a light incident surface and a light emission surface thereof are perpendicular to the axis A. For the liquid crystal display element 40, a typical liquid crystal display component is used which provides high linearity and small diffusion. It is designed that a voltage is applied to the liquid crystal display element 40, and the liquid crystal display element 40 is switched over between an ON state in which the voltage is applied and an OFF state in which no voltage is applied by the controller. Liquid crystal molecules (not shown) are sealed up in an interior of the liquid crystal display element 40 in a predetermined alignment direction in the OFF state. When a voltage is applied thereto, the liquid crystal display element 40 is switched to the ON state, whereupon the alignment direction of the liquid crystal molecules in the interior of the liquid crystal display element 40 is designed to be changed 90 degrees. The liquid crystal display element 40 is switched over between the ON state and the OFF state in a time-division manner by the controller.

As a result of the alignment direction of the liquid crystal molecules being controlled in the way described above, a polarization direction of the diffracted light L2 which is transmitted or passes through the liquid crystal display element 40 is changed 90 degrees. As a result, as shown in FIG. 2B, the liquid crystal display element 40 is divided into a light transmitting area 40a where the diffracted light L2 is transmitted and a light blocking area 40b where the diffracted light L2 is blocked. FIG. 2B shows an example in which an upwardly directed arrow-shaped pattern is defined as the light transmitting area 40a. In the liquid crystal display element 40, a portion corresponding to an arbitrary pattern is defined as the light transmitting area 40a by the controller. Among the diffracted light L2 projected in a dot pattern onto the liquid crystal display element 40, the diffracted light L2 projected onto the light transmitting area 40a passes through the liquid crystal display element 40, and the diffracted light L2 projected onto the light blocking area 40b is blocked (hereinafter, the diffracted light L2 which passes through the liquid crystal display element 40 will be referred to as “image light L3”.). In other words, the liquid crystal display element 40 generates image light L3 using a portion of the diffracted light L2 in a dot pattern.

The image light L3 generated in the liquid crystal display element 40 is emitted directly from the projection opening 10a to the exterior of the housing and is then projected onto the projection target such as a screen. As shown in FIG. 2C, projected light PL projected on the projection target is displayed in an upwardly directed arrow-shaped pattern similar to the pattern defined in the liquid crystal display element 40 as a collection of light in a dot pattern. Namely, in the projected light PL projected onto the projection target, only the upwardly directed arrow-shaped pattern corresponding to the light transmitting area 40a is displayed as a display area PL1, and the remaining portion constitutes a non-display area PL2 that is not displayed (in FIG. 2C, the non-display area PL2 is indicated by light dotted points.).

The projected light PL is generated from the laser light L1, and hence, the size and number of dots making up the projected light PL remain unchanged even in the event that a distance between the diffractive optical element 30 and the projection target changes. Due to this, irrespective of the distance between the diffractive optical element 30 and the projection target, the projected light PL projected onto the projection target can be brought into focus, and the number of pixels remains constant. The size of pixels of the liquid crystal display element 40 is made sufficiently small compared to the size of the dot lights DL which are projected from the diffractive optical element 30 on the liquid crystal display element 40 (for example, one fifth or smaller), whereby interference fringes by the dot lights DL are reduced. In addition, a transmission loss in the liquid crystal display element 40 is reduced by combining a polarized light emitted from the light-emitting element 22 and a polarized light incident on the liquid crystal display element 40.

Thus, as has been described heretofore, the projector 10 of the first or present embodiment includes the light-emitting element 22, the diffractive optical element 30 on which the laser light L1 from the light-emitting element 22 is incident, and the liquid crystal display element 40 on which the diffracted light L2 diffracted by the diffractive optical element 30 is incident. Then, the diffractive optical element 30 projects the diffracted light L2 emitted therefrom on the liquid crystal display element 40 in a dot pattern, and the liquid crystal display element 40 generates the image light L3 using the portion of the light projected in a dot pattern from the diffractive optical element 30.

With the projector 10 of the present embodiment, the diffracted light L2 from the diffractive optical element 30 is projected in a dot pattern onto the liquid crystal display element 40, and the diffracted light L2 then passes through the light transmitting area 40a of the liquid crystal display element 40 which is defined into the arbitrary pattern to thereby generate the image light L3. Then, the image light L3 arrives at the projection target, whereby an image of the pattern defined in the liquid crystal display element 40 is projected onto the projection target. With a conventional projector, a lens generates multiple bright points aligned in a specific direction on a projection surface by multiple laser beams diffracted by a diffractive optical element and projects a rectilinear pattern extending along the specific direction on the projection surface. Due to this configuration, when trying to change patterns that are projected onto the projection surface from one to a different pattern, the relevant optical component such as a lens needs to be replaced by an optical component corresponding to the different pattern. With the present embodiment, an arbitrary pattern can be projected onto the projection target only by controlling the alignment direction of the liquid crystal molecules in the liquid crystal display element 40. In this way, with the projector 10 of the present embodiment, patterns to be projected can be changed without replacing optical components.

In addition, the projector 10 of the present embodiment includes the liquid crystal display element 40 as a display element. Due to this configuration, an arbitrary pattern can be projected onto the projection target only by controlling the alignment direction of the liquid crystal molecules in the liquid crystal display element 40.

Further, the projector 10 of the present embodiment includes the projection opening 10a configured to project the image light L3 generated in the liquid crystal display element 40 onto the projection target, so that the image light L3 generated in the liquid crystal display element 40 is projected directly from the projection opening 10a ono the projection target. As described above, the projected light PL projected onto the projection target can be brought into focus irrespective of the distance between the diffractive optical element 30 and the projection target, and hence, a lens component or the like does not have to be provided between the liquid crystal display element 40 and the projection opening 10a, thereby making it possible to reduce the size and cost of the projector 10. Additionally, a lens component or the like does not have to be provided between the liquid crystal display element 40 and the projection opening 10a, and hence, the diffracted light L2 does not have to be incident perpendicularly on the liquid crystal display element 40. Due to this configuration, no lens component needs to be provided between the diffractive optical element 30 and the liquid crystal display element 40, and the diffracted light L2 from the diffractive optical element 30 is directly incident on the liquid crystal display element 40. As a result, a reduction in size and cost of the projector 10 can be attained.

With the projector 10 of the present embodiment, the light-emitting element 22 is the laser light source. In this way, by using the laser light source, the diffracted light L2 diffracted by the diffractive optical element 30 can be projected onto the liquid crystal display element 40 in a dot pattern.

### Second Embodiment

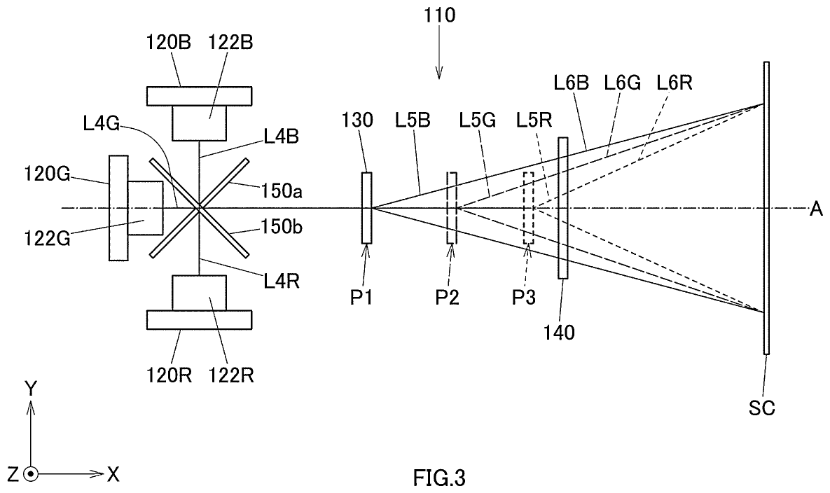

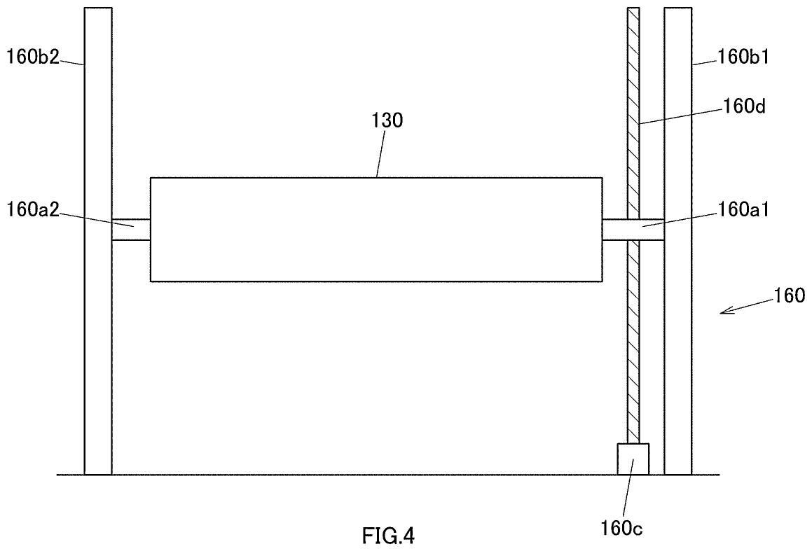

Subsequently, referring to FIGS. 3 and 4, a second embodiment of the present disclosure will be described. As shown in FIG. 3, a projector 110 according to the second embodiment includes, as light sources, a blue light-emitting element (a first light source) 122B, a red light-emitting element (a second light source) 122R, and a green light-emitting element (a third light source) 122G. In addition, the projector 110 includes two dichroic mirrors (a first dichroic mirror, a second dichroic mirror) 150a, 150b, a diffractive optical element 130, and a liquid crystal display element 140. Although a projection opening is provided in a housing of the projector 110 as in the case with the first embodiment, the illustration of the projection opening is omitted in FIG. 3.

The blue light-emitting element 122B is a laser light source provided on a blue light source substrate 120B and is made up of a semiconductor light-emitting element such as a laser diode, and emits blue laser light L4B which is light in a blue wavelength band (light in a first wavelength band). The red light-emitting element 122R is a laser light source provided on a red light t source substrate 120R and is made up of a semiconductor light-emitting element such as a laser diode, and emits red laser light L4R which is light in a red wavelength band (light in a second wavelength band). The green light-emitting element 122G is a laser light source provided on a green light source substrate 120G and is made up of a semiconductor light-emitting element such as a laser diode, and emits green laser light L4G which is light in a green wavelength band (light in a third wavelength band).

The green light-emitting element 122G is disposed in such a way that an optical axis of green laser light L4G emitted therefrom is on and along an axis A (an X direction). The blue light-emitting element 122B is disposed in such a way that an optical axis of blue laser light L4B emitted therefrom is perpendicular to the axis A. The red light-emitting element 122R is disposed in such a way that an optical axis of red laser light LAR emitted therefrom is perpendicular to the axis A and that a light emission surface thereof oppositely faces the blue light-emitting element 122B. That is, the blue light-emitting element 122B and the red light-emitting element 122R are disposed in such a way as to oppositely face each other in a Y direction which is perpendicular to the X direction. In the projector 110 of the second or present embodiment, light emission timings at which light is emitted from each of the blue, red, and green light-emitting elements 122B, 122R, 122G are controlled by the controller. The light emission timings at which light is emitted from each of the blue, red, and green light-emitting elements 122B, 122R, 122G may be set arbitrarily by the user in accordance with an image to be projected (a pattern defined in the liquid crystal display element 140). For example, it may be designed so that when wanting to project an image denoting a permission of passage, green laser light L4G is emitted, whereas when wanting to project an image denoting a prohibition of passage, red laser light LAR is emitted.

The two dichroic mirrors, 150a and 150b, are arranged such that parts of each overlap in a manner orthogonal to each other when viewed from the Z-direction, which is perpendicular to both the X and Y directions. They are positioned opposite to the respective emission surfaces of the blue light-emitting element 122B, the red light-emitting element 122R, and the green light-emitting element 122G. Of the two dichroic mirrors, one dichroic mirror, that is, the dichroic mirror 150b transmits light in the red wavelength band and light in the green wavelength band and reflects light in the blue wavelength band. The other dichroic mirror, that is, the dichroic mirror 150a transmits light in the blue wavelength band and light in the green wavelength band and reflects light in the red wavelength band. The diffractive optical element 130 is configured in the same way as the diffractive optical element 30 of the first embodiment and is disposed in such a way that a light incident surface and a light emission surface thereof are perpendicular to the axis A on a light emission side of the green light-emitting element 122G.

In the projector 110, blue laser light L4B emitted from the blue light-emitting element 122B is reflected in a direction in which an optical axis thereof follows the axis A by the dichroic mirror 150b and is then incident on the diffractive optical element 130. The red laser light L4R emitted from the red light-emitting element 122R is reflected in a direction in which an optical axis thereof follows the axis A by the dichroic mirror 150a and is then incident on the diffractive optical element 130. The green laser light L4G emitted from the green light-emitting element 122G passes through the two dichroic mirrors and is then incident on the diffractive optical element 130.

The diffractive optical element 130 diffracts each of the blue laser light L4B, the red laser light L4R, and the green laser light L4G which are incident thereon into multiple lights in such a way that the multiple lights are projected in a dot pattern onto the liquid crystal element 140 and then projects them towards the liquid crystal display element 140 (hereinafter, among the diffracted lights emitted from the diffractive optical element 130 to be projected onto the liquid crystal display element 140, a diffracted light based on the blue laser light L4B will be referred to as a “blue diffracted light L5B”, a diffracted light based on the red laser light L4R will be referred to as a “red diffracted light L5R”, and a diffracted light based on the green laser light L4G will be referred to as a “green diffracted light L5G”.). Here, respective wavelengths of the blue, red, and green laser light L4B, L4R, L4G differ from one another, and hence, as shown in FIG. 3, spread angles of the blue diffracted light L5B, the red diffracted light L5R, and the green diffracted light L5G towards the liquid crystal display element 140 differ from one another. Then, the spread angles spread wider in the order of the red diffracted light L5R, the green diffracted light L5G, and the blue diffracted light L5B.

The liquid crystal display element 140 is configured in the same way as the liquid crystal display element 40 of the first embodiment and is disposed in such a way that a light incident surface and a light emission surface thereof are perpendicular to the axis A on a light emission side of the diffractive optical element 130. In the diffracted light L2 which is projected in a dot pattern onto the liquid crystal display element 140, light transmitting a light transmitting area of the liquid crystal display element 140 is emitted from the projection opening in the housing as image light and is then projected onto a screen SC (hereinafter, in the image light, an image light based on the blue diffracted light L5B will be referred to as a “blue image light L6B”, an image light based on the red diffracted light L5R will be referred to as a “red image light L6R”, and an image light based on the green diffracted light L5G will be referred to as a “green image light L6B”.).

Patterns of colors corresponding to the respective wavelength bands of the blue, red, and green light-emitting elements 122B, 122R, 122G are projected onto the screen SC in such a way as to match a pattern defined in the liquid crystal display element 140. Namely, a blue pattern is projected onto the screen SC at a timing at which the blue laser light L4B is emitted from the blue light-emitting element 122B, a red pattern is projected onto the screen SC at a timing at which the red laser light L4R is emitted from the red light-emitting element 122R, and a green pattern is projected onto the screen SC at a timing at which the green laser light L4B is emitted from the green light-emitting element 122G.

Here, the projector 110 of the present embodiment includes a diffractive optical element driver (a moving mechanism) 160 configured to move the diffractive optical element 130 in a front-rear direction between the dichroic mirrors 150a, 150b and the liquid crystal display element 140 on the axis A, in other words, on optical paths of the blue, red, and green laser lights L4B, L4R, L4G which are emitted from the blue, red, and green light-emitting elements 122B, 122R, 122G, respectively.

As shown in FIG. 4, the diffractive optical element driver 160 has a pair of sliders 160a1, 160a2, a pair of slider guides 160b1, 160b2, a motor 160c, and a screw 160d. The sliders 160a1, 160a2 are provided individually on a left side and a right side of the diffractive optical element 130 and are guided so as to move freely in the front-rear direction by the corresponding slide guides 160b1, 160b2. The screw 160d is passed through the slider 160a1. A ball-screw structure is provided between the slider 160al and the screw 160d. The motor 160c is driven and controlled by the controller.

When the motor 160c is driven to rotate, causing the screw 160d to rotate, the slider 160al moves back and forth together with the diffractive optical element 130 along the slide guide 160b1. The slider 160a2 is attached to the other side of the diffractive optical element 130 in such a manner as to face oppositely the slider 160a1 attached to one side of the diffractive optical element 130. The slider 160a2 is guided in the front-rear direction by the slide guide 160b2. As a result of this configuration, the diffractive optical element 130 is displaced in the front-rear direction by the slider 160a1 and is guided accurately in the front-rear direction by the slider 160a2.

The diffractive optical element driver 160 is controlled by the controller in such a way as to move the diffractive optical element 130 so as to change respective light collective positions of the blue, red, and green diffracted lights L5B, L5R, L5G that are emitted from the diffractive optical element 130 to the liquid crystal display element 140. The diffractive optical element driver 160 can move the diffractive optical element 130 in the front-rear direction by use of, for example, a system in which the diffractive optical element 130 is fixed to a slide guide which travels straight on a guide rail or a configuration using an actuator such as a piezo-electric device, in addition to the configuration using the ball-screw structure shown in FIG. 4.

In the projector 110 of the present embodiment, the diffractive optical element driver 160 causes the diffractive optical element 130 to move in the front-rear direction in accordance with the spread angles of the blue, red, and green diffracted lights L5B, L5R, L5G towards the liquid crystal display element 140 so that respective sizes of patterns based on the blue image light L6B, the red image light L6R, and the green image light L6G which are projected onto the screen SC become equal to one another. For example, as shown in FIG. 3, at the timing at which the blue image light L6B is projected onto the screen SC, the diffractive optical element 130 is caused to move to a position P1 which is located away from the liquid crystal display element 140, allowing the blue laser light L4B to be incident. Then, at the timing at which the green image light L6G is projected onto the screen SC, the diffractive optical element 130 is caused to move to a position P2 which is located slightly away from the liquid crystal display element 140, allowing the green laser light L4G to be incident. In addition, at the timing at which the red image light L6R is projected onto the screen SC, the diffractive optical element 130 is caused to move to a position P3 which is located near to the liquid crystal display element 140, allowing the red laser light L4R to be incident.

Thus, as has been described heretofore, the projector 110 of the present embodiment includes, as the light-emitting elements, the blue light-emitting element 122B configured to emit light in the blue wavelength band, the red light-emitting element 122R configured to emit light in the red wavelength band, and the green light-emitting element 122G configured to emit light in the green wavelength band. As a result, a blue pattern, a red pattern, and a green pattern can individually be projected onto the screen SC.

In addition, the projector 110 of the present embodiment includes the diffractive optical element driver 160 configured to cause the diffractive optical element 130 to move on the optical paths of the lights from the blue, red, and green light-emitting elements 122B, 122R, 122G, so that the blue laser light L4B from the blue light-emitting element 122B, the red laser light L4R from the red light-emitting element 122R, and the green laser light L4G from the green light-emitting element 122G are incident on the diffractive optical element 130 at the different positions P1, P2, P3, respectively. According to this configuration, the respective sizes (the projection ranges) of the blue, red, and green image lights L6B, L6R, L6G which are projected onto the screen SC can be made equal to one another by changing the position of the diffractive optical element 130 in accordance with the respective spread angles of the blue, red, and green diffracted lights L5B, L5R, L5G which are incident from the diffractive optical element 130 on the liquid crystal display element 140.

Here, a first modified example of the present embodiment will be described. In this modified example, the respective sizes (the projection ranges) of the blue, red, and green image lights L6B, L6R, L6G which are projected onto the screen SC can be made equal to one another by changing sizes of patterns defined in the liquid crystal display element 140 in accordance with the respective spread angles of the blue, red, and green diffracted lights L5B, L5R, L5G which are incident from the diffractive optical element 130 on the liquid crystal display element 140 without moving the diffractive optical element 130 in the front-rear direction.

In addition, a second modified example of the present embodiment will be described. In this modified example, three diffractive optical elements 130 are provided at predetermined intervals in the front-rear direction on the axis A, so that blue, red, and green laser lights L4B, L4R, L4G are emitted simultaneously from the blue, red, and green light-emitting elements 122B, 122R, 122G, respectively, whereby the blue, red, and green laser lights L4B, L4R, L4G are incident on the different diffractive optical elements 130. As a result, a full-color pattern can be projected and displayed on the screen SC. In this case, the intervals at which the diffractive optical elements 130 are provided are made to be a minute distance (for example, 1 mm), so that it becomes possible to reduce a risk that the sizes (the projection ranges) of the blue, red, green diffracted lights L5B, L5R, L5G which are projected onto the liquid crystal display element 140 are caused to differ due to the different spread angles of the blue, red, green diffracted lights L5B, L5R, L5G and a risk that respective resolutions of blue, red, and green colors (that is, the number of a dot pattern of the blue, red, green diffracted lights L5B, L5R, L5G which are used at the display area PL1) differ from one another in association with the risk of the sizes being caused to differ. Light emission timings of the blue, red, and green light-emitting elements 122B, 122R, 122G may be controlled in a time-division manner by the controller.

### Third Embodiment

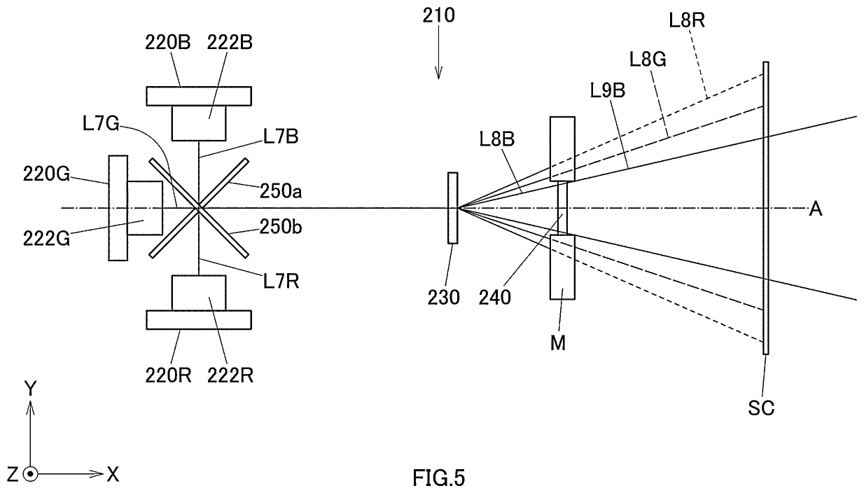

Subsequently, referring to FIG. 5, a third embodiment of the present disclosure will be described. As shown in FIG. 5, a projector 210 according to the third embodiment differs from the projector 110 of the second embodiment in that a part of a liquid crystal display element 240 is covered by a mask M and that there is provided no diffractive optical element driver. The remaining configurations remain the same as those of the second embodiment, and hence, the description of the same configurations will be omitted here. Here, in FIG. 5, reference numerals resulting by adding 100 to the reference numerals shown in FIG. 3 denote the same constituent components as those described in the second embodiment. In addition, in FIG. 5, reference numerals L7B, L7R, L7G denote blue laser light, red laser light, and green laser light, respectively, reference numerals L8B, L8R, L8G denote blue diffracted light, a red diffracted light, and green diffracted light, respectively, and a reference numeral L9B denotes blue image light.

In the projector 210 of the third embodiment, the position of a diffractive optical element 230 is fixed on an axis A between two dichroic mirrors 250a, 250b and the liquid crystal display element 240. Then, in the liquid crystal display element 240, an outside portion of a range where a blue diffracted light L8B, having a smallest spread angle in blue, red, and green diffracted lights L8B, L8R, L8G which are emitted from the diffractive optical element 230, is projected is covered by the mask M. Due to this configuration, in red diffracted light L8R and green diffracted light L8G which are emitted from the diffractive optical element 230 to the liquid crystal display element 240, only portions of the red and green diffracted lights L8R, L8G which fall in ranges corresponding to the spread angle of the blue diffracted light L8B are projected in a dot pattern onto the liquid crystal display element 240. Thus, portions of the red and green diffracted lights L8R, L8G which fall in the outside of the relevant ranges are blocked by the mask M.

With the projector 210 of the present embodiment that is configured as described above, a blue image light L9B, the portion of the red diffracted light L8R, and the portion of the green diffracted light L8G can be projected onto a screen SC within the same range as the spread angle of the blue diffracted light L8B. As a result, although a slight light loss is generated as a result of the portions of the red diffracted light L8R and the green diffracted light L8G being blocked by the mask M, a blue pattern, a red pattern, and a green pattern can be projected onto a predetermined range of the screen SC without providing a diffractive optical element driver. This embodiment also enables the projection of patterns in full color on the screen SC. In this case, it becomes possible to reduce a risk that respective resolutions of blue, red, and green colors (that is, the number of dots of the blue, red, green diffracted lights L8B, L8R, L8G which are irradiated on the portion of the liquid crystal display element 240 which is not covered by the mask M) differ from one another by moving the position of the liquid crystal display element 240 towards the diffractive optical element 230 or adjusting grating spacings (a space between a concave portion and a convex portion) of the diffractive optical element 230 in such a way as to reduce the spread angles of the blue, red, and green diffracted lights L8B, L8R, L8G. Light emission timings of the blue, red, and green light-emitting elements 222B, 222R, 222G may be controlled in a time-division manner by the controller.

### Fourth Embodiment

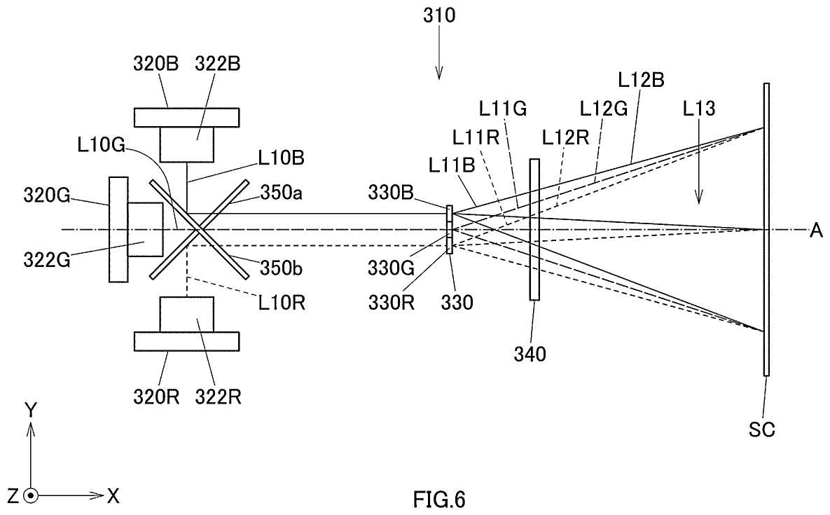

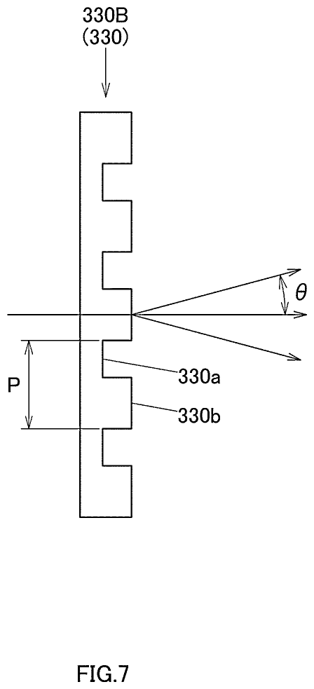

Subsequently, referring to FIGS. 6 and 7, a fourth embodiment of the present disclosure will be described. As shown in FIG. 6, a projector 310 according to the fourth embodiment differs from the projector 110 of the second embodiment in that it does not include a diffractive optical element driver and in the irradiation positions of blue laser light L10B and red laser light L20R with respective to two dichroic mirrors 350a, 350b, as well as the configuration of a diffractive optical element 330. The remaining configurations are the same as those of the second embodiment, and hence, the description of the same configurations will be omitted here. Here, in FIG. 6, reference numerals resulting by adding 200 to the reference numerals shown in FIG. 3 denote the same constituent components as those described in the second embodiment except for the diffractive optical element 330. In addition, in FIG. 6, reference numerals L10B, L10R, L10G denote blue laser light, red laser light, and green laser light, respectively, reference numerals L11B, L11R, L11G denote blue diffracted light, red diffracted light, and green diffracted light, respectively, and reference numerals L12B, L12R, L12G denote blue image light, red image light, and green image light, respectively.

In the projector 310 of the fourth embodiment, the diffractive optical element 330 is divided into three regions of a blue incident region (a first region) 330B on which blue laser light L10B is incident, a red incident region (a second region) 330R on which red laser light L10R is incident, and a green incident region (a third region) 330G on which green laser light L10G is incident. In other words, in the diffractive optical element 330, the blue, red, and green incident regions 330B, 330R, 330G are provided on the same or identical plane. The blue, red, and green incident regions 330B, 330R, 330G are defined substantially equally along a left-right direction in the diffractive optical element 330. Then, a left-hand side portion of the diffractive optical element 330 is defined as the blue incident region 330B, a right-hand side portion of the diffractive optical element 330 is defined as the red incident region 330R, and a portion defined between the blue incident region 330B and the red incident region 330R is defined as the green incident region 330G.

In the present embodiment, the blue laser light L10B emitted from a blue light-emitting element 322B is controlled to be incident on the blue incident region 330B. More specifically, the blue laser light L10B is irradiated at a position of one dichroic mirror 350b that is displaced from the overlapping position of the two dichroic mirrors 350a and 350b, so that the blue laser light L10B is reflected toward the blue incident region 330B.

In addition, the red laser light L10R emitted from a red light-emitting element 322R is controlled to be incident on the red incident region 330R. More specifically, the red laser light L10R is irradiated at a position of the other dichroic mirror 350a that is displaced from the overlapping position of the two dichroic mirrors 350a and 350b, so that the red laser light L10R is reflected toward the red incident region 330R.

Additionally, in the projector 330 of the present embodiment, grating spacings of diffraction gratings making up the blue incident region 330B, the red incident region 330R, and the green incident region 330G differ from one another. Specifically speaking, grating spacings on the blue, red, and green incident regions 330B, 330R, 330G are set in accordance with wavelengths of the blue, red, and green laser lights L11B, L11R, L11G (wavelength bands of blue, red, and green lights) so that the spread angles of blue, red, and green diffracted lights L11B, L11R, L11G towards the liquid crystal display element 340 are substantially equal to one another. As one example, as shown in FIG. 7, when the spread angles θ of the blue, red, and green diffracted lights L11B, L11R, L11G from the diffractive optical element 330 are set at 15 degrees, a grating spacing in the blue incident region 330B, that is, the distance P between a concave portion 330a and a convex portion 330b which make up one grating is set at 30.7 nm. Here, the spread angle θ is calculated using the formula λ/P, where λ (nm) is the wavelength of each laser beam L10B, L10R, and L10G.

In this way, the respective spread angles θ of the blue diffracted light L11B (a blue image light L12B), the red diffracted light L11R (a red image light L12R), and the green diffracted light L11G (a green image light L12G) emitted from the respective incident regions 330B, 330R, 330G can be made substantially equal to one another by varying the grating spacings of the respective incident regions 330B, 330R, 330G of the diffractive optical element 330 in accordance with the wavelengths of the blue, red, and green laser lights L10B, L10R, L10G. As a result, respective sizes of the blue, red, and green image lights L12B, L12R, L12G which are projected onto a screen SC can be equalized without moving the diffractive optical element 330 in accordance with the spread angles of the blue, red, and green laser lights L10B, L10R, L10G.

Moreover, in this embodiment, since there is no need to move the diffractive optical element 330 as described above, it is possible to project a pattern onto the screen SC in full color by controlling the simultaneous emission of the laser lights L10B, L10R, and L10G from the respective light-emitting elements 322B, 322R, and 322G. For example, a white pattern can be displayed on the screen SC.

Here, when a pattern is projected to be displayed in full colors in this way, in order to diffract the blue diffracted light L11B and the red diffracted light L11R inwards (towards the green incident region 330G) in such a way that the spread angles θ of the blue diffracted light L11B and the red diffracted light L11R match the spread angle θ of the green diffracted light L11G to thereby reduce a minute deviation in projection position on the screen SC which would result from the difference in arrangement of the blue, red, and green incident regions 330B, 330R, 330G of the diffractive optical element 330, a light emission side of a concave/convex structure of a diffraction grating is preferably inclined in the blue incident region 330B and the red incident region 330R, or the arrangement of the blue light-emitting element 322B and the red light-emitting element 322R or the angle at which the two dichroic mirrors 350a, 350b are overlapped one on the other is preferably adjusted. In addition, a deviation in a dot pattern of each of the blue, red, and green diffracted lights L11B, L11R, L11G which are incident on the liquid crystal element 340 can be reduced by narrowing spaces (for example, to 1 mm or smaller) between the blue, red, and green laser lights L10B, L10R, L10G which are incident on the diffractive optical element 330 (that is, spaces between the blue, red, and green incident regions 330B, 330R, 330G).

Thus, as has been described heretofore, with the projector 310 of the present embodiment, the diffractive optical element 330 includes the blue incident regions 330B on which light from the blue light-emitting element 322B is incident, the red incident region 330R on which light from the red light-emitting element 322R is incident, and the green incident region 330G on which light from the green light-emitting element 322G is incident which are provided on the same or identical plane. Then, the grating spacings of the diffraction gratings making up the blue incident region 330B, the red incident region 330R, and the green incident region 330G differ from one another in accordance with the wavelength bands of the blue, red, and green lights which are incident thereon respectively. According to this configuration, the spread angles of the blue, red, and green diffracted lights L11B, L11R, L11G can be made substantially equal to one another by varying the grating spacings of the diffraction gratings making up the blue, red, and green incident regions 330B, 330R, 330G from one another in such a way that the spread angles of the blue, red, and green diffracted lights L11B, L11R, L11G towards the liquid crystal display element 340 become substantially equal to one another. Thus, a full-color display can be realized without separately providing a mechanism for moving the diffractive optical element 330.

In addition, with the projector 310 of the present embodiment, the blue incident region 330B, the red incident region 330R, and the green incident region 330G diffract the corresponding lights in such a way that the projection ranges of the blue, red, and green diffracted lights L11B, L11R, L11G which are emitted from the blue incident region 330B, the red incident region 330R, and the green incident region 330G, respectively, so as to be projected onto the screen SC become substantially equal to one another. According to this configuration, a minute deviation in projection position on the screen SC that would result from the difference in arrangement of the blue, red, and green incident regions 330B, 330R, 330G can be reduced by adjusting the combination of the diffraction gratings having the different grating spacings in the blue, red, and green incident regions 330B, 330R, 330G.

The projector 310 of the present embodiment includes the other dichroic mirror, that is, the dichroic mirror 350b configured to reflect the blue laser light L10B from the blue light-emitting element 322B towards the diffractive optical element 330 and transmit the light from the green light-emitting element 322G and the one dichroic mirror, that is, the dichroic mirror 350a configured to reflect the light from the red light-emitting element 322R towards the diffractive optical element 330 and transmit the light from the green light-emitting element 322G and disposed in the position where the dichroic mirror 350a is overlapped with the other dichroic mirror 350b. Then, the light from the blue light-emitting element 322B is irradiated at a position of the other dichroic mirror 350b that is displaced from the overlapping position so that the light is reflected toward the blue incident region 330B. In addition, the light from the red light-emitting element 322R is irradiated at a position of the one dichroic mirror 350a that is displaced from the overlapping position so that the light is reflected toward the red incident region 330R. According to this configuration, the blue, red, and green laser lights L10B, L10R, L10G can be incident on the corresponding blue, red, and green incident regions 330B, 330R, 330G of the diffractive optical element 330.

Thus, as has been described heretofore, with the projectors 10, 110, 210, 310 of the first, second, third and fourth embodiments, lights diffracted by the diffractive optical elements 30, 130, 230, 330 are projected in a dot pattern onto the liquid crystal display elements 40, 140, 240, and 340. Therefore, an arbitrary pattern can be projected onto the screen SC (the projection target) only by controlling the alignment direction of the liquid crystal molecules in the liquid crystal display elements 40, 140, 240, 340. Further, with the projectors 110, 310 according to the second embodiment and the fourth embodiment, a full-color display can be realized on the screen (the projection target) SC by simultaneously emitting laser light in blue, red, and green colors.

The embodiments that have been described heretofore are presented as examples, and hence, there is no intention to limit the scope of the present disclosure by the embodiments. These novel embodiments can be carried out in other various forms, and various omissions, replacements and modifications can be made thereto without departing from the spirit and scope of the present disclosure. Those resulting embodiments and their modifications are included in the scope and gist of the present disclosure and are also included in the scope of inventions claimed for patent under claims below and their equivalents. For example, while the liquid crystal display element is used as the display element in the embodiments described above, the present disclosure is not limited thereto. For example, a DMD (digital micromirror device) and a structure configured to form an optical image by reflected light of the DMD may be provided. Even in this case, an arbitrary pattern can be projected onto the projection target by controlling a reflection mode of the DMD.

What is claimed is:

1. A projector comprising:
a light source;
a diffractive optical element on which light from the light source is incident; and
a display on which the light diffracted by the diffractive optical element is incident,
wherein the diffractive optical element projects the light emitted therefrom onto the display in a dot pattern, and
wherein the display generates image light using at least a portion of the light projected in a dot pattern.

2. The projector according to claim 1,
wherein the display comprises a liquid crystal display element.

3. The projector according to claim 1, further comprising:
a projection opening configured to project the image light generated by the display onto a projection target,
wherein the image light generated by the display is projected from the projection opening onto the projection target either directly or via a reflection mirror.

4. The projector according to claim 1,
wherein the diffractive optical element projects the light emitted therefrom directly onto the display.

5. The projector according to claim 1,
wherein the light source comprises a first light source configured to emit light in a first wavelength band, a second light source configured to emit light in a second wavelength band, and a third light source configured to emit light in a third wavelength band.

6. The projector according to claim 5, further comprising:
a moving mechanism configured to move the diffractive optical element along an optical path of light from the light source,
wherein the light from each of the first light source, the second light source, and the third light source is incident on the diffractive optical element at different positions.

7. The projector according to claim 5,
wherein the diffractive optical element comprises a first region on which light from the first light source is incident, a second region on which light from the second light source is incident, and a third region on which light from the third light source is incident, all of which are provided on a same plane, and
wherein the first region, the second region, and the third region have different grating spacings of diffraction gratings according to wavelength bands of incident light.

8. The projector according to claim 7,
wherein the first region, the second region, and the third region of the diffractive optical element diffract light in such a manner that respective ranges of the image lights emitted individually from the first region, the second region, and the third region to be projected onto a projection target is substantially equal.

9. The projector according to claim 5, further comprising:
a first dichroic mirror configured to reflect light from the first light source towards the diffractive optical element and transmit light from the third light source; and
a second dichroic mirror configured to reflect light from the second light source towards the diffractive optical element and transmit light from the third light source, and is configured so that a portion of the second dichroic mirror overlaps a portion of the first dichroic mirror when viewed from a predetermined direction,
wherein the diffractive optical element comprises a first region on which light from the first light source is incident, a second region on which light from the second light source is incident, and a third region on which light from the third light source is incident,
wherein the first light source irradiates light at a position of the first dichroic mirror that is displaced from an overlapping position so that the light is reflected toward the first region, and
wherein the second light source irradiates light at a position of the second dichroic mirror that is displaced from an overlapping position so that the light is reflected toward the second region.

10. The projector according to claim 1, wherein the light source comprises a laser light source.
